(19) United States
(12) Patent Application Publication
(10) Pub. No.: US 2014/0108264 A1
(43) Pub. Date: Apr. 17, 2014

(54) SERVICE INTERACTION METHOD OF FLASH SERVICE PLATFORM AND CORRESPONDING FLASH SERVICE PLATFORM

(71) Applicant: Tencent Technology (Shenzhen) Company Limited, Shenzhen (CN)

(72) Inventors: Rihui SHI, Shenzhen (CN); Xin JIN, Shenzhen (CN); Yongting CHEN, Shenzhen (CN); Dong CHEN, Shenzhen (CN)

(73) Assignee: Tencent Technology (Shenzhen) Company Limited, Shenzhen (CN)

(21) Appl. No.: 14/106,649

(22) Filed: Dec. 13, 2013

Related U.S. Application Data
(63) Continuation of application No. PCT/CN2013/085289, filed on Oct. 16, 2013.

(30) Foreign Application Priority Data
Oct. 17, 2012 (CN) 201210393881.9

(51) Int. Cl. G06Q 20/08

(52) U.S. Cl. CPC G06Q 20/08
USPC 705/71; 705/44

(57) ABSTRACT

A computer-implemented method is implemented while rendering an application in a Flash interface, wherein the Flash interface is connected to a Flash server. The method comprises: suspending the application and displaying a payment selection option in the Flash interface; upon detecting a user selection of the payment selection option, sending a request for downloading a payment plug-in to the Flash server; receiving and initializing the payment plug-in, the payment plug-in including an SWF file and a callback function; displaying a payment authorization option in the Flash interface based on the SWF file; upon detecting a user selection of the payment authorization option, sending payment authorization information to the payment platform; receiving payment confirmation from the payment platform by invoking the callback function; and resuming the application by updating displayed content of the Flash interface based on the payment confirmation.

### RELATED APPLICATIONS

This application is a continuation application of PCT Patent Application No. PCT/CN2013/085289, entitled “SERVICE INTERACTION METHOD OF FLASH SERVICE PLATFORM AND CORRESPONDING FLASH SERVICE PLATFORM” filed on Oct. 16, 2013, which claims priority to Chinese Patent Application No. 201210393881.9, entitled “SERVICE INTERACTION METHOD OF FLASH SERVICE PLATFORM AND CORRESPONDING FLASH SERVICE PLATFORM,” filed on Oct. 17, 2012, both of which are hereby incorporated by reference in their entirety.

### FIELD OF THE INVENTION

The present invention relates to the field of Internet technologies, and more particularly to a convenient service interaction method of a Flash service platform and a corresponding Flash service platform.

### BACKGROUND OF THE INVENTION

With the development of Internet technologies, Flash games as an emerging type of games are advantageous in simple operation, small volume of files, and no need of installation and are favored by many game users.

Currently, service interaction (for example, payment, recharge, and query services) between a Flash game platform and a game payment platform can be implemented in the following manners:

1. In a Flash game, a user clicks a corresponding button to open a web page in a browser and performs interaction with the game payment platform, and after the interaction is completed, the user closes the web page manually or through a timer and returns to the Flash game.

2. In a Flash game, a user clicks a corresponding button to load an interaction web interface in the page of the Flash game, and after the interaction is completed, the user re-loads the Flash game in the current page.

3. Implement service interaction through mobile phone short messages or by other means.

When the first interaction manner is adopted, the interaction result cannot be fed back to the Flash game through the web page. Thus the data state in the Flash game cannot be updated in real time after the interaction is completed and the updating is delayed.

When the second interaction manner is adopted, the interaction interface is loaded in the current page, which may cause loss of the data state in the Flash game since the Flash interface is closed.

The above two interaction manners both affect user experience.

When the third interaction manner is adopted, the Flash game platform needs to make a corresponding interaction solution in accordance with the service interaction means, which is hard to achieve uniform operation and uniform management of the Flash game in the platform.

Therefore, it is in need of a convenient service interaction method of a Flash service platform and a corresponding Flash service platform, to solve the problems in the prior art.

### SUMMARY

The present application provides a Flash payment method and apparatus based to improve upon and avoid many risks of existing Flash payment methods.

In accordance with some embodiments, a computer-implemented method is performed at a computing device having one or more processors and memory storing programs executed by the one or more processors. The method is implemented while rendering an application in a Flash interface, wherein the Flash interface is connected to a Flash server. The method comprises: suspending the application and displaying a payment selection option in the Flash interface when a pre-set condition is met; upon detecting a user selection of the payment selection option, sending a request for downloading a payment plug-in to the Flash server; receiving and initializing the payment plug-in, the payment plug-in including an SWF file and a callback function; displaying a payment authorization option in the Flash interface based on the SWF file; upon detecting a user selection of the payment authorization option, sending payment authorization information to the payment platform; receiving payment confirmation from the payment platform by invoking the callback function; and resuming the application by updating displayed content of the Flash interface based on the payment confirmation.

In accordance with some embodiments of the present invention, a Flash displaying device comprises one or more processors: memory; and one or more programs stored in the memory and to be executed by the processor. The one or more programs include instructions for: while rendering an application in a Flash interface, wherein the Flash interface is connected to a Flash server: suspending the application and displaying a payment selection option in the Flash interface when a pre-set condition is met; upon detecting a user selection of the payment selection option, sending a request for downloading a payment plug-in to the Flash server; receiving and initializing the payment plug-in, the payment plug-in including an SWF file and a callback function; displaying a payment authorization option in the Flash interface based on the SWF file; upon detecting a user selection of the payment authorization option, sending payment authorization information to the payment platform; receiving payment confirmation from the payment platform by invoking the callback function; and resuming the application by updating displayed content of the Flash interface based on the payment confirmation.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

FIG. 1 is a flowchart of a Flash interaction method in accordance with some embodiments;

FIG. 2 is a flowchart of a Flash interaction method in accordance with some embodiments;

FIG. 3 is a time chart of the methods as illustrated in FIG. 2;

FIG. 4 is a flowchart of a Flash interaction method in accordance with some embodiments;

FIG. 5 is a schematic structural diagram of a Flash displaying device in accordance with some embodiments;

FIG. 6 is a schematic structural diagram of a Flash displaying device in accordance with some embodiments;

FIG. 7 is a flowchart of a Flash interaction method in accordance with some embodiments;

FIG. 7A is a flowchart of a Flash interaction method in accordance with some embodiments;

FIGS. 8A-8D are displays of an device in accordance with some embodiments; and

FIG. 9 is a schematic structural diagram of a Flash displaying device in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

Embodiments of the present invention are illustrated below with reference to the accompanying drawings, which exemplify specific embodiments that can be implemented by the present invention. The directional terms mentioned in the present invention, like “above”, “below”, “front”, “back”, “left”, “right”, “inside”, “outside”, and “side”, refer to the directions in the accompanying drawings. Therefore, the directional terms are only used for facilitating illustration and understanding of the present invention instead of limiting the present invention.

In the drawings, units with similar structures are represented by the same symbols.

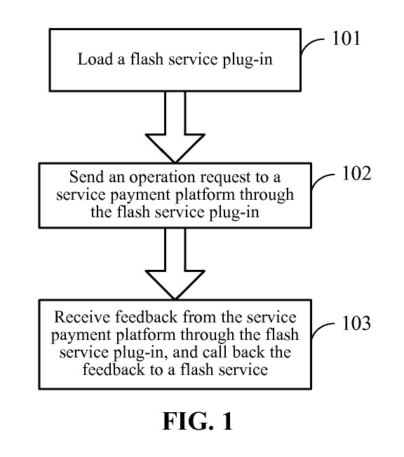

FIG. 1 is a flowchart of a Flash interaction method in accordance with some embodiments. Referring to FIG. 1, the service interaction method of the Flash service platform (which operates on a Flash server) includes the following steps.

Step 101: Load a Flash service plug-in.

Step 102: Send an operation request to a service payment platform through the Flash service plug-in.

Step 103: Receive feedback from the service payment platform through the Flash service plug-in, and call back the feedback to a Flash service.

The service interaction method of the Flash service platform ends in Step 103.

In the present invention, the Flash service platform sends, through the Flash service plug-in configured therein, service operation requests such as payment, query and recharge to the service payment platform, and calls back feedback from the service payment platform to the Flash service through the Flash service plug-in. In this manner, a user can complete the service operation requests such as payment, query and recharge in the implementation of the Flash service through the Flash service plug-in, which does not affect the user experience of the service; and uniform operation and uniform management of multiple types of Flash services may also be implemented through the Flash service plug-in. The Flash service includes, but is not limited to, a Flash game.

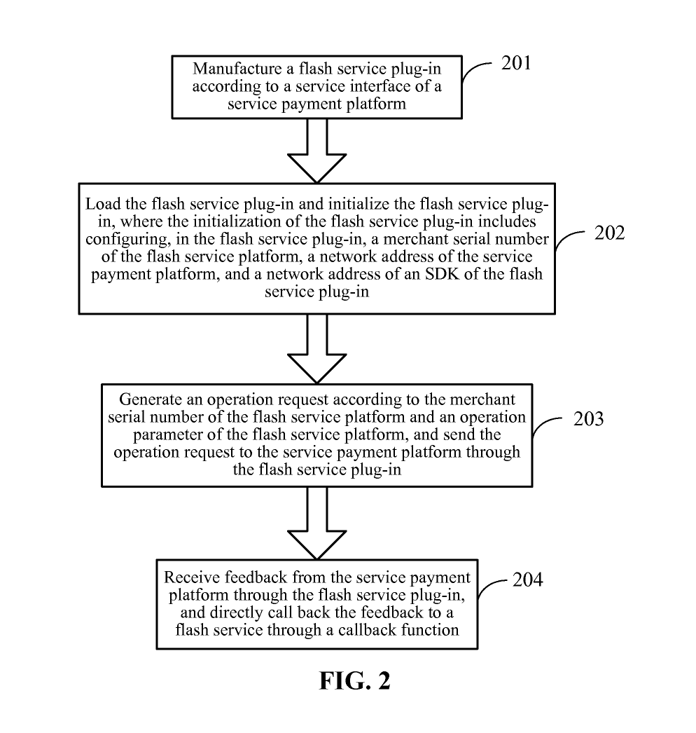

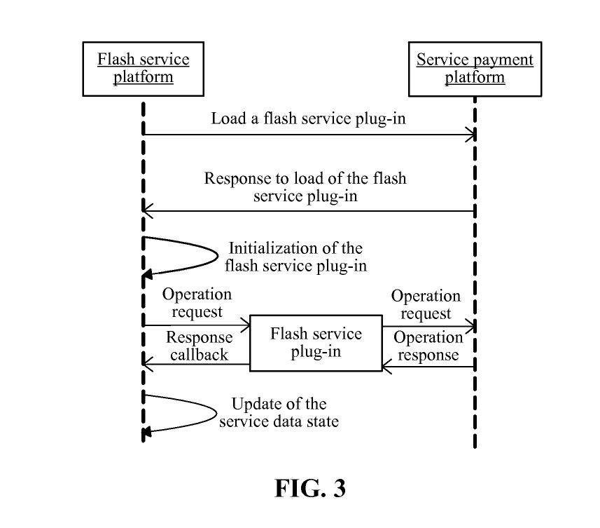

FIG. 2 is a flowchart of a Flash interaction method in accordance with some embodiments, and FIG. 3 is a time chart of the methods as illustrated in FIG. 2. Referring to FIG. 2 and FIG. 3, the service interaction method of the Flash service platform includes the following steps.

Step 201: Generate a Flash service plug-in according to a service interface of a service payment platform.

Step 202: Load the Flash service plug-in and initialize the Flash service plug-in, where the initialization of the Flash service plug-in includes configuring, in the Flash service plug-in, a merchant serial number of the Flash service platform, a network address of the service payment platform, and a network address of a software development kit (SDK) of the Flash service plug-in.

Step 203: Generate an operation request according to the merchant serial number of the Flash service platform and an operation parameter of the Flash service platform, and send the operation request to the service payment platform through the Flash service plug-in.

Step 204: Receive feedback from the service payment platform through the Flash service plug-in, and directly call back the feedback to a Flash service through a callback function.

The service interaction method of the Flash service platform ends in Step 204.

The flowchart of the some embodiments is illustrated in detail below with reference to FIG. 3. FIG. 3 is a time chart of the methods as illustrated in FIG. 2.

In Step 201, the Flash service plug-in is generated according to the service interface of the service payment platform. Since the Flash service plug-in is used to perform service operation with the service payment platform, the Flash service plug-in needs to be generated in the Flash service platform according to the service interface provided by the service payment platform, to ensure the compatibility between the Flash service plug-in and the service payment platform. This step is optional, and if a Flash service plug-in corresponding to the service interface of the service payment platform already exists, there is no need to generate a Flash service plug-in, and the existing Flash service plug-in can be directly used.

Step 202 is performed subsequently.

In Step 202, the Flash service platform loads the Flash service plug-in, and when the service payment platform responds to load of the Flash service plug-in, the Flash service platform initializes operation on the Flash service plug-in. The initializing operation of the Flash service plug-in includes, but is not limited to, configuring, in the Flash service plug-in, a merchant serial number of the Flash service platform, a network address of the service payment platform, and a network address of an SDK of the Flash service plug-in. The merchant serial number of the Flash service platform is used to represent an identity of a user sending a service operation request to the service payment platform, the network address of the service payment platform is used to represent a sending address of the service operation request, and the network address of the SDK of the Flash service plug-in is used to invoke a specific service operation tool in the Flash service plug-in. After the initializing operation of the Flash service plug-in, the Flash service plug-in can perform corresponding user service interaction for the corresponding service payment platform.

Step 203 is performed subsequently.

In Step 203, an operation request is generated according to the merchant serial number of the Flash service platform and an operation parameter of the Flash service platform, and the operation request is sent to the service payment platform through the Flash service plug-in. For example, in a Flash game, the operation parameter includes, but is not limited to, a payment sequence number, a virtual item serial number, a virtual item quantity, a virtual item unit price, recharge amount, and amount query. In this step, the Flash service platform also generates a callback function corresponding to the operation request, and the callback function is used for directly calling back feedback from the service payment platform to the Flash service. After converting the operation into the operation request, the Flash service platform sends the operation request to the service payment platform through the Flash service plug-in; and since the Flash service platform is configured with the Flash service plug-in, the Flash service platform does not need to load an interaction web page, and directly sends the operation request from the background to the service payment platform through the Flash service plug-in, which does not affect the user experience of the service.

Step 204 is performed subsequently.

In Step 204, after processing the operation request, the service payment platform sends corresponding feedback (operation response) to the Flash service plug-in, and the Flash service plug-in directly calls back the feedback to the Flash service through the callback function generated by the Flash service platform in advance. In this manner, the result of the user service operation request can be informed without causing interruption of the Flash service, and the service data state can thus be updated in time.

Till now, the whole process of service interaction of the Flash service platform is completed.

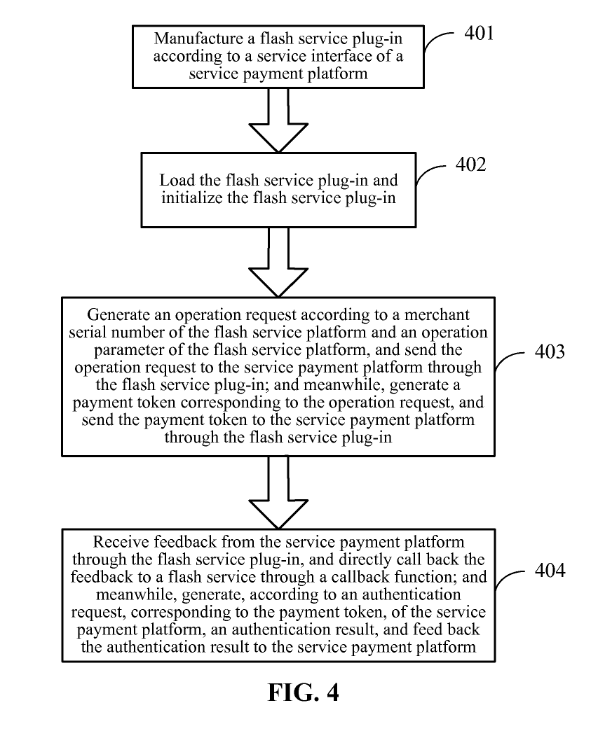

FIG. 4 is a flowchart of a Flash interaction method in accordance with some embodiments. Referring to FIG. 4, the service interaction method of the Flash service platform includes the following steps.

Step 401: Generate a Flash service plug-in according to a service interface of a service payment platform.

Step 402: Load the Flash service plug-in and initialize the Flash service plug-in.

Step 403: Generate an operation request according to a merchant serial number of the Flash service platform and an operation parameter of the Flash service platform, and send the operation request to the service payment platform through the Flash service plug-in; and meanwhile, generate a payment token corresponding to the operation request, and send the payment token to the service payment platform through the Flash service plug-in.

Step 404: Receive feedback from the service payment platform through the Flash service plug-in, and directly call back the feedback to a Flash service through a callback function; and meanwhile, generate, according to an authentication request, corresponding to the payment token, of the service payment platform, an authentication result, and feed back the authentication result to the service payment platform.

The service interaction method of the Flash service platform ends in Step 404.

Step 401 is the same as or similar to Step 201 of FIG. 2, and for the specific implementation, reference can be made to the description of Step 201 of FIG. 2.

Step 402 is the same as or similar to Step 202 of FIG. 2, and for the specific implementation, reference can be made to the description of Step 202 of FIG. 2.

In Step 403, in addition to the actions of Step 203 of FIG. 2, the Flash service platform further generates a payment token corresponding to the operation request, and sends the payment token to the service payment platform through the Flash service plug-in.

In Step 404, in addition to the actions of Step 204 of FIG. 2, after receiving the payment token, the service payment platform generates an authentication request corresponding to the payment token, and sends the authentication request to the Flash service platform; and after receiving the authentication request, the Flash service platform processes the authentication request, generates a corresponding authentication result, and feeds back the authentication result to the service payment platform, and the service payment platform performs corresponding processing on service interaction according to the authentication result.

Till now, the whole process of service interaction of the Flash service platform is completed.

In this embodiment, the payment token is configured to further enhance the security of the service interaction between the Flash service platform and the service payment platform.

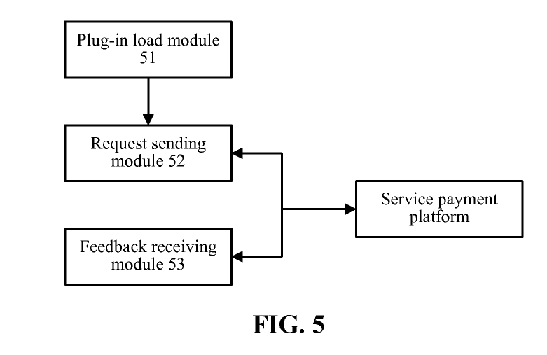

The present invention also provides a Flash service platform. FIG. 5 is a schematic structural diagram of a Flash displaying device in accordance with some embodiments. Referring to FIG. 5, the Flash service platform includes a plug-in load module 51, a request sending module 52, and a feedback receiving module 53.

In the present invention, when the Flash service platform sends a service operation request, the plug-in load module 51 loads a corresponding Flash service plug-in; the request sending module 52 sends an operation request to a service payment platform through the Flash service plug-in; the service payment platform generates feedback after processing the operation request, and the feedback receiving module 53 receives the feedback through the Flash service plug-in, and calls back the feedback to a Flash service.

In the present invention, the Flash service platform sends, through the Flash service plug-in configured therein, service operation requests such as payment, query and recharge to the service payment platform, and calls back feedback from the service payment platform to the Flash service through the Flash service plug-in. In this manner, a user can complete the service operation requests such as payment, query and recharge in the implementation of the Flash service through the Flash service plug-in, which does not affect the user experience of the service; and uniform operation and uniform management of multiple types of Flash services may also be implemented through the Flash service plug-in.

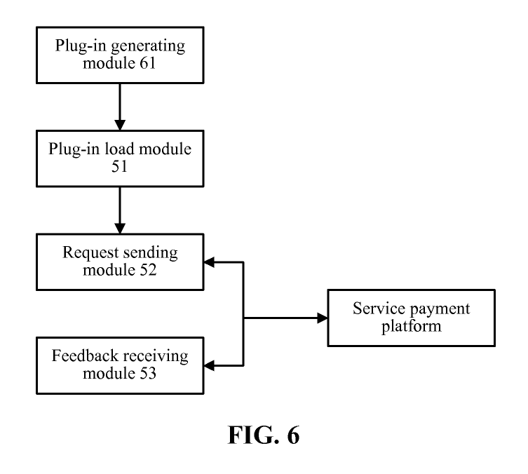

FIG. 6 is a schematic structural diagram of a Flash displaying device in accordance with some embodiments. Referring to FIG. 6, the Flash service platform also includes a plug-in generating module 61.

The plug-in generating module 61 is configured to generate a Flash service plug-in according to a service interface of a service payment platform; the plug-in load module 51 is specifically used for loading the Flash service plug-in and initializing the Flash service plug-in, where the initialization of the Flash service plug-in includes, but is not limited to, configuring, in the Flash service plug-in, a merchant serial number of the Flash service platform, a network address of the service payment platform, and a network address of an SDK of the Flash service plug-in; the request sending module 52 is specifically used for generating an operation request according to the merchant serial number of the Flash service platform and an operation parameter of the Flash service platform, and sending the operation request to the service payment platform through the Flash service plug-in; and the feedback receiving module 53 is specifically used for receiving feedback from the service payment platform through the Flash service plug-in, and directly calling back the feedback to a Flash service through a callback function.

The request sending module 52 of the Flash service platform according to the present invention may also include a token delivery unit, which is used for generating a payment token corresponding to the operation request, and sending the payment token to the service payment platform through the Flash service plug-in. The feedback receiving module 53 of the Flash service platform may also include a token authentication unit, which is used for generating, according to an authentication request, corresponding to the payment token, of the service payment platform, an authentication result, and feeding back the authentication result to the service payment platform.

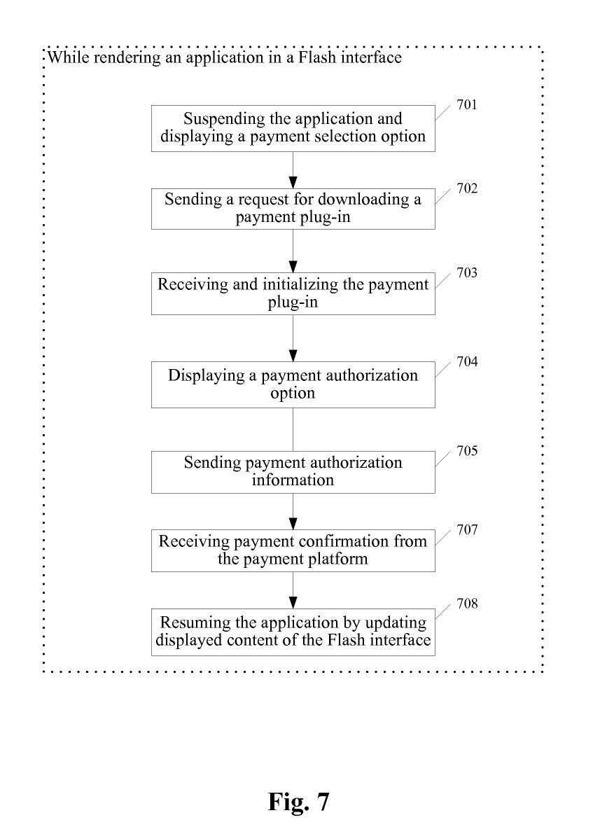

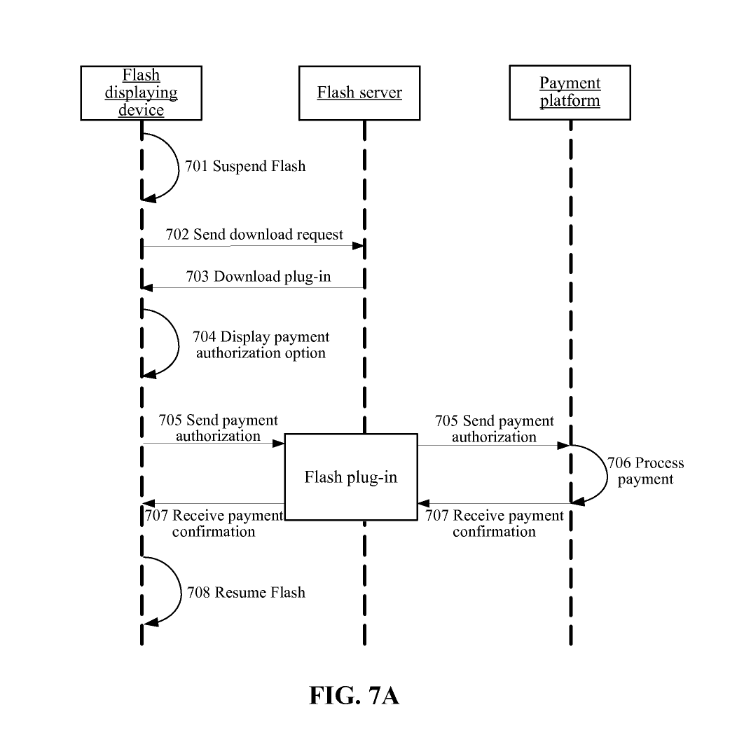

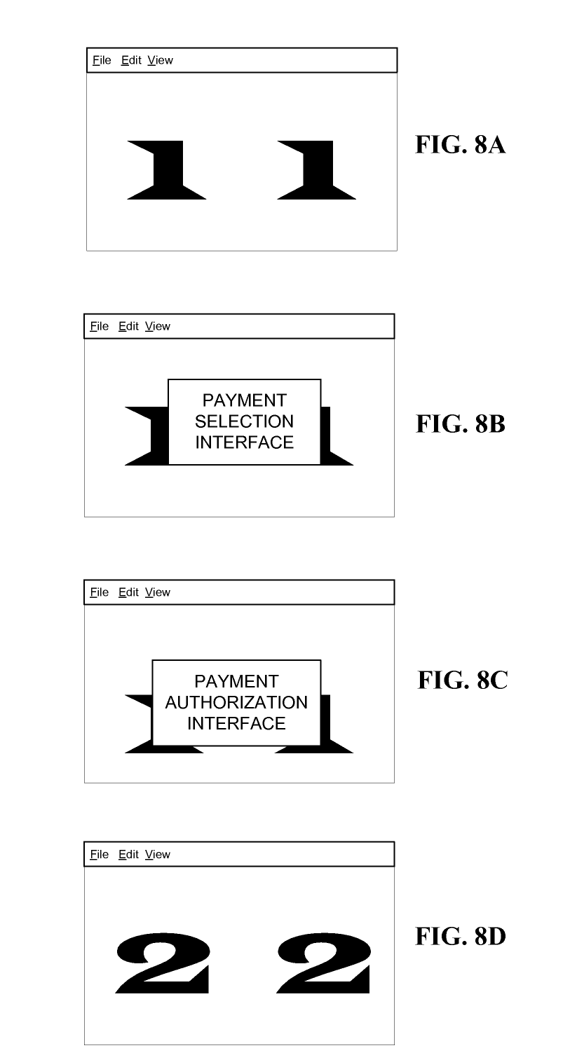

FIG. 7 and FIG. 7A are both flowcharts of Flash interaction methods in accordance with some embodiments. FIG. 7 illustrates the steps taken by the Flash displaying device. FIG. 7A illustrates the interaction among the Flash displaying device, the Flash service server and the payment platform. FIGS. 8A to 8D are exemplary screenshots of a Flash displaying device in accordance with some embodiments.

The computer-implemented method as illustrated in FIG. 7 is performed at a computing device having one or more processors and memory storing programs executed by the one or more processors. The method is implemented while rendering an application in a Flash interface, wherein the Flash interface is connected to a Flash server.

In step 701, the device suspends the application and displays a payment selection option in the Flash interface when a pre-set condition is met. FIG. 8A depicts an exemplary screenshot of the display of the device immediately before the pre-set condition is met. FIG. 8B depicts an exemplary screenshot of the display of the device after the pre-set condition is met. As shown in FIG. 8B, the application is suspended and kept open. The pre-set conditions can be various. For example, if the Flash interface is displaying a movie, the movie is suspended after 5 minutes since its start and the payment selection interface jumps out and asks the user to choose a payment selection option in the payment selection interface in order to continue watching the movie. In this example, the pre-set condition is since the movie starts 5 minutes. In accordance with some embodiments, the pre-set condition includes detecting a user's operation indicative of intent to purchase. For example, a user is playing a game with the Flash service. The user wants to buy a few virtual items in the game while playing and selects a shopping cart icon in the bottom of the interface. The payment selection interface pops out to facilitate the user's desired transaction. In this example, the pre-set condition is detecting the user's selection of the shopping cart icon. In accordance with some embodiments, the payment selection interface includes a few payment options among which a user may choose.

In step 702, upon detecting a user selection of the payment selection option, the device sends a request for downloading a payment plug-in to the Flash server.

In step 703, the device receives and initializes the payment plug-in, the payment plug-in including an SWF (ShockWave Flash or Small Web Format) file and a callback function. In accordance with some embodiments, the SWF file includes information regarding how to reach the payment platform that is provided by the Flash server. Alternatively, the payment request is sent to the Flash server first and then gets forwarded to the payment platform. In accordance with some embodiments, the payment platform operates on the Flash server. In some embodiments, there are multiple payment platforms, each of which corresponds to one option of payment in the payment selection interface.

The callback function is configured to update data of the application in the Flash interface according to the payment confirmation in step 708, in a way, e.g., described in step 404 of FIG. 4.

In step 704, the device displays a payment authorization option in the Flash interface based on the SWF file. FIG. 8C depicts an exemplary screenshot of the display of the device when the device displays the payment authorization option. From a user's view, the payment authorization interface containing a payment authorization option is a natural follow-up interface that follows the user's selection of payment method. The displayed payment authorization interface at least partly depends on the payment method selected by the user. For example, when a user selects to pay by PayPal, the payment authorization interface is configured to receive user inputs with regard to PayPal. In accordance with some embodiments, the user authorization interface asks the user to fill in identification information, such as account name, password, etc. The user authorization interface can also ask the user to verify the payment amount or other information.

In step 705, upon detecting payment authorization operations from the user, the device sends payment authorization information to the payment platform. In accordance with some embodiments, the payment authorization information includes user identification information.

In accordance with some embodiments, the plug-in further includes a public encryption key of an asymmetrical encryption method authorized by a payment platform and the payment platform possesses a private decryption key of the asymmetrical encryption method. According to the asymmetrical encryption method, the payment authorization information is encrypted with the public encryption key and is decrypted by the private decryption key. The public encryption key is different from the private decryption key. Even if the public encryption key is intercepted, it cannot be used for decryption because only the private decryption key can be used to decrypt the information that is encrypted by the public encryption key.

In step 706, the payment platform processes the payment request. In accordance with some embodiments, the payment platform is configured to maintain an account of the user and to process the payment transaction of the user independently. In such case, the payment platform directly deducts the payment amount from the user's account and sends the amount to the seller's account. Alternatively, the payment platform is configured to send at least part of the decrypted payment authorization information to a finance entity, e.g., a bank. The finance entity processes the payment and sends payment confirmation to the payment platform.

In some embodiments, the payment platform is configured to send at least part of the payment authorization information to a finance entity, e.g., a bank. The payment platform operates on a computer that is connected with a computer of the finance entity. After the payment platform sends at least part of the decrypted payment authorization to the finance entity, the finance entity uses the information to process the transaction and notifies the payment platform once the transaction is completed.

The payment platform can operate on the Flash server, with a finance entity or independently.

In step 707, the device receives payment confirmation from the payment platform by invoking the callback function. In some embodiments, the payment confirmation is sent only to the device. In accordance with some other embodiments, the payment confirmation is also sent to the Flash server, which forwards the payment confirmation to the device.

In step 708, the device resumes the application by updating displayed content of the Flash interface based on the payment confirmation. FIG. 8D depicts an exemplary screenshot of the display of the device when the application is resumed the content of the Flash interface is updated. The displayed content of the Flash interface is updated after the payment confirmation is received. The Flash server updates the content of the Flash interface after receiving payment notification from the Flash application (e.g., Flash plug-in) or payment platform. For example, a user can continue watching a movie after making the payment. In another example, a game player can see that the newly purchased virtual item is displayed in the updated content of the Flash game interface. In some embodiments, the updated displayed content of the Flash interface based on the payment confirmation reflects the amount of the payment. For a Flash game interface, the quantity and varieties of virtual items reflect the amount of the payment.

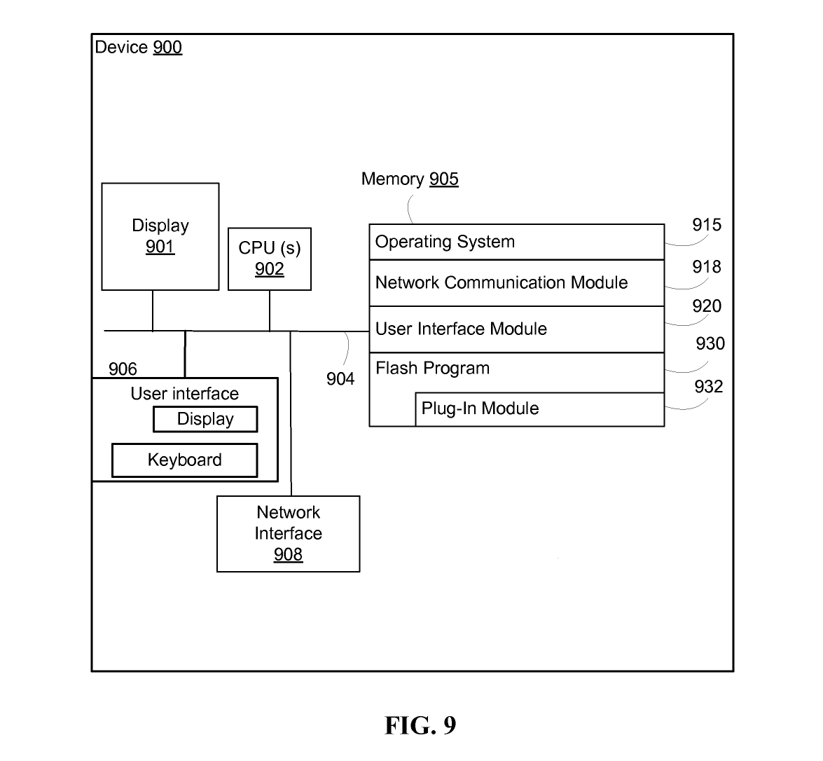

FIG. 9 is a diagram of an example implementation of a Flash displaying device in accordance with some embodiments. While certain specific features are illustrated, those skilled in the art will appreciate from the present disclosure that various other features have not been illustrated for the sake of brevity and so as not to obscure more pertinent aspects of the implementations disclosed herein. To that end, the server computer 900 includes one or more processing units (CPU's) 902, one or more network or other communications interfaces 908, a display 901, memory 905, and one or more communication buses 904 for interconnecting these and various other components. The communication buses may include circuitry (sometimes called a chipset) that interconnects and controls communications between system components. The memory 905 includes high-speed random access memory, such as DRAM, SRAM, DDR RAM or other random access solid state memory devices; and may include non-volatile memory, such as one or more magnetic disk storage devices, optical disk storage devices, Flash memory devices, or other non-volatile solid state storage devices. The memory 905 may optionally include one or more storage devices remotely located from the CPU(s) 902. The memory 905, including the non-volatile and volatile memory device(s) within the memory 905, comprises a non-transitory computer readable storage medium.

In some implementations, the memory 905 or the non-transitory computer readable storage medium of the memory 905 stores the following programs, modules and data structures, or a subset thereof including an operating system 915, a network communication module 918, a user interface module 920, and a text-processing program 930.

The operating system 915 includes procedures for handling various basic system services and for performing hardware dependent tasks.

The network communication module 918 facilitates communication with other devices via the one or more communication network interfaces 908 (wired or wireless) and one or more communication networks, such as the internet, other wide area networks, local area networks, metropolitan area networks, and so on.

The user interface module 920 is configured to receive user inputs through the user interface 906.

The Flash program 930 is configured to process “Macromedia Flash” data and display video, audio and multimedia content in display 901. The Flash program 930 includes a Plug-in Module 932, which is configured to receive and initialize the plug-in received from the Flash server.

In accordance with various embodiments, a Flash service plug-in is configured. The Flash service plug-in has good compatibility with each of the Flash service platform and the service payment platform, a user can complete service interaction during the implementation of the service, and the Flash service plug-in can be compatible with multiple Flash service platforms simultaneously. The Flash service plug-in is compatible with a corresponding Flash service platform by changing the merchant serial number of the Flash service platform, thereby achieving convenient service interaction between the Flash service platform and the service payment platform. Therefore, the plug-in solves technical problems that the steps of the existing service interaction method of the Flash service platform are complex and the user service interaction efficiency is low.

In accordance with some embodiments, a payment token may also be configured to perform payment authentication, which further enhances the security of the service interaction between the Flash service platform and the service payment platform.

While particular embodiments are described above, it is to be understood they are not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
at a computing device having one or more processors and memory storing programs executed by the one or more processors:
while rendering an application in a Flash interface, wherein the Flash interface is connected to a Flash server:
suspending the application and displaying a payment selection option in the Flash interface when a pre-set condition is met;
upon detecting a user selection of the payment selection option, sending a request for downloading a payment plug-in to the Flash server;
receiving and initializing the payment plug-in, wherein the payment plug-in includes an SWF file and a callback function;
displaying a payment authorization option in the Flash interface based on the SWF file;
upon detecting a user selection of the payment authorization option, sending payment authorization information to a payment platform;
receiving payment confirmation from the payment platform by invoking the callback function; and
resuming the application by updating displayed content of the Flash interface based on the payment confirmation.

2. The method of claim 1, wherein the pre-set condition includes detecting a user's operation indicative of intent to purchase.

3. The method of claim 1, wherein the payment platform is configured to maintain an account of the user and process the payment transaction of the user.

4. The method of claim 1, wherein the payment platform is configured to send at least part of the payment authorization information to a finance entity.

5. The method of claim 1, wherein the callback function is configured to update data of the application in the Flash interface according to the payment confirmation.

6. The method of claim 1, wherein the updated displayed content of the Flash interface based on the payment confirmation reflects the amount of the payment.

7. The method of claim 1, wherein the payment platform operates on the Flash server.

8. The method of claim 1, wherein the plug-in further includes a public encryption key of an asymmetrical encryption method authorized by the payment platform and the payment platform possesses a private decryption key of the asymmetrical encryption method.

9. The method of claim 8, wherein the payment authorization information is encrypted with the public encryption key before being sent to the payment platform.

10. A Flash displaying device, comprising:
one or more processors;
memory; and
one or more program modules stored in the memory and configured for execution by the one or more processors, the one or more program modules including instructions for:
while rendering an application in a Flash interface, wherein the Flash interface is connected to a Flash server:
suspending the application and displaying a payment selection option in the Flash interface when a pre-set condition is met;
upon detecting a user selection of the payment selection option, sending a request for downloading a payment plug-in to the Flash server;
receiving and initializing the payment plug-in, wherein the payment plug-in includes an SWF file and a callback function;
displaying a payment authorization option in the Flash interface based on the SWF file;
upon detecting a user selection of the payment authorization option, sending payment authorization information to a payment platform;
receiving payment confirmation from the payment platform by invoking the callback function; and
resuming the application by updating displayed content of the Flash interface based on the payment confirmation.

11. The device of claim 10, wherein the pre-set condition includes detecting a user's operation indicative of intent to purchase.

12. The device of claim 10, wherein the payment platform is configured to maintain an account of the user and process the payment transaction of the user.

13. The device of claim 10, wherein the payment platform is configured to send at least part of the payment authorization information to a finance entity.

14. The device of claim 10, wherein the callback function is configured to update data of the application in the Flash interface according to the payment confirmation.

15. The device of claim 10, wherein the updated displayed content of the Flash interface based on the payment confirmation reflects the amount of the payment.

16. The device of claim 10, wherein the payment platform operates on the Flash server.

17. The device of claim 10, wherein the plug-in further includes a public encryption key of an asymmetrical encryption method authorized by the payment platform and the payment platform possesses a private decryption key of the asymmetrical encryption method.

18. The device of claim 17, wherein the payment authorization information is encrypted with the public encryption key before being sent to the payment platform.

19. A non-transitory computer readable storage medium, storing one or more programs for execution by one or more processors of a computer system, the one or more programs including instructions for:
while rendering an application in a Flash interface, wherein the Flash interface is connected to a Flash server:
suspending the application and displaying a payment selection option in the Flash interface when a pre-set condition is met;
upon detecting a user selection of the payment selection option, sending a request for downloading a payment plug-in to the Flash server;
receiving and initializing the payment plug-in, wherein the payment plug-in includes an SWF file and a callback function;
displaying a payment authorization option in the Flash interface based on the SWF file;
upon detecting a user selection of the payment authorization option, sending payment authorization information to a payment platform;
receiving payment confirmation from the payment platform by invoking the callback function; and
resuming the application by updating displayed content of the Flash interface based on the payment confirmation.
